(19) United States
(12) Patent Application Publication
(10) Pub. No.: US 2026/0360247 A1
(43) Pub. Date: Nov. 12, 2026

(54) Method for Operating a Battery Pack

(71) Applicant: Robert Bosch GmbH, Stuttgart (DE)

(72) Inventors: Andreas Gonser, Wolfschlugen (DE); Holger Wernerus, Pliezhausen (DE)

(21) Appl. No.: 19/671,599

(22) Filed: May 8, 2026

(30) Foreign Application Priority Data
May 12, 2025 (DE) 10 2025 118 148.9

(51) Int. Cl. G08B 21/18; G08B 5/36

(52) U.S. Cl. CPC G08B 21/182; G08B 5/36

(57) ABSTRACT

A method is disclosed for operating a battery pack, in particular an exchangeable battery pack, which has a plurality of battery cells. The method includes (i) sensing single cell voltages of all battery cells, (ii) determining a maximum voltage difference between all detected single cell voltages, (iii) determining a degree of balancing by comparing the determined voltage difference with a predetermined first threshold value, and (iv) outputting information about the determined degree of balancing, in particular by way of a charge state indicator of the battery pack, wherein at least a first degree of balancing and a second degree of balancing are displayed.

This application claims priority under 35 U.S.C. § 119 to patent application no. DE 10 2025 118 148.9, filed on May. 12, 2025 in Germany, the disclosure of which is incorporated herein by reference in its entirety.

### BACKGROUND

The present disclosure relates to a method for operating a battery pack and to a battery pack for loads.

Methods for operating battery packs are known, in particular those that include lithium-ion cells as battery cells, by way of which primarily age-related limitations of the usable capacity are determined. Such limitations result in a fully charged battery pack no longer having the original runtime available. The remaining runtime or usable capacity is often indicated as a percentage of the originally available runtime or capacity. For example, the term "State of Health (SOH)" is used for this purpose. Known methods for determining the SOH require a large amount of data to be acquired and/or additional sensors. Determining and displaying the SOH is thus often complex and time-consuming.

### SUMMARY

In contrast, the method according to the disclosure with the features set forth below is characterized in that a particularly simple, time-efficient, and cost-effective method can be provided, by way of which information about the state of the battery pack can be obtained. In particular, the method can be carried out without requiring additional sensors or components.

This is achieved according to the disclosure by a method for operating a battery pack, in particular an exchangeable battery pack, wherein the battery pack comprises a plurality of battery cells, comprising the steps of:
sensing individual cell voltages of all battery cells,
determining a maximum voltage difference between all sensed individual cell voltages,
determining a degree of balancing by comparing the determined voltage difference with a predetermined first threshold value, and
outputting information about the determined degree of balancing, in particular by way of a charge state indicator of the battery pack, wherein at least a first degree of balancing and a second degree of balancing are indicated.

In particular, precisely one value corresponding to a difference between the highest of all detected individual cell voltages and the lowest of all detected individual cell voltages is determined as the maximum voltage difference. Preferably, the detected individual cell voltages are first compared with one another.

Preferably, the individual cell voltages of all battery cells are detected simultaneously and/or within a predetermined period of time. The maximum voltage difference is determined between all individual cell voltages detected simultaneously and/or within the predetermined period of time.

In particular, the predetermined first threshold value corresponds to a defined, constant voltage value.

Particularly preferably, the information is output by way of an output unit. Thus, information about whether the battery pack is balanced, imbalanced, or at least partially imbalanced can preferably be provided to the user of the battery pack.

A degree of balancing is in particular considered to be information that indicates whether the different, individual battery cells are balanced or at least partially imbalanced in their current cell voltages. Preferably, a balanced state is considered to exist when all single cell voltages are substantially the same, in particular within a predetermined tolerance range. It is considered to be imbalanced when one or more single cell voltages deviate from one another by more than a specified tolerance.

In other words, in the method, the instantaneous single cell voltages of all battery cells of the exchangeable battery pack are detected and compared with one another by way of single cell monitoring. Based on a maximum voltage difference between all detected single cell voltages, the degree of balancing of the battery pack is subsequently determined by comparing the determined difference with the predetermined first threshold value.

The method thus offers the advantage that a particularly simple and inexpensive method is provided that can be carried out in a particularly simple and time-efficient manner, by way of which information about the state of the battery pack can be reliably obtained. In particular, when a good balance of the single cell voltages is determined, it can be determined that the battery pack still has a high capacity compared to its original capacity, and, for example, still has no significant signs of aging that reduce the capacity. Furthermore, upon detection of a poor degree of balancing or a severe imbalance, it can be ascertained that, for example, due to aging, there are significant capacity limitations of the battery pack.

Preferred developments of the disclosure are also set forth below.

Preferably, the step of determining the degree of balancing further comprises detecting a balanced state of the battery cells when the determined voltage difference is less than or equal to the predetermined first threshold value and detecting an at least partially imbalanced state of the battery cells when the determined voltage difference is greater than the predetermined first threshold value. In particular, a balanced state is considered to exist when all battery cells have a substantially equal capacity. That is, upon detection of the balanced state, it may be determined that the battery pack is in an operable state. An at least partially imbalanced condition can be considered to exist when some inequality exists in the capacities of the individual battery cells. For example, based on this, it can be assumed that the battery pack has limited performance as compared to its original state. In particular, it can be assumed that a failure is imminent.

Preferably, determining the degree of balancing further comprises detecting the imbalanced state of the battery cells, and preferably an existing failure of at least one battery cell and/or the entire battery pack, when the determined voltage difference is greater than a predetermined second threshold value. The second threshold value is greater than the first threshold value. That is to say, two-stage detection can be performed, wherein a severe imbalance can be detected in the case of very large detected voltage differences, where, for example, a failure of the battery pack can be assumed to occur soon. An intermediate, partially imbalanced condition may provide an indication that the capacity of the battery pack is no longer optimal, but that there is still an operational capability.

Preferably, the first degree of balancing is present when a determined voltage difference is below the first threshold value, and the second degree of balancing is present when a determined voltage difference is above the first threshold value. The first degree of balancing corresponds to a failure-free battery pack, and the second degree of balancing corresponds to a defective battery pack. Thus, the determination and differentiation of the degree of balancing can be carried out in a particularly simple and efficient manner.

Preferably, the information is output visually, in particular by way of an LED display. For example, the degree of balancing is indicated by lighting up a different number of LEDs. Alternatively or additionally, the display preferably occurs by lighting up LEDs in different colors. Further alternatively, a display may preferably occur by way of seven-segment displays and/or by way of LCD displays, preferably in percentage values and/or with text. This allows a simple and cost-effective option of providing information to the user, which is also particularly user-friendly.

Preferably, the method further comprises the step of: Detecting a predetermined user input using an input device of the battery pack. In particular, the input device comprises a button, preferably on a housing of the battery pack. The further steps of the method, in particular sensing the single-cell voltages, determining the maximum voltage difference, and determining the degree of balancing, are performed in response to detecting the predetermined user input. That is to say, determining the degree of balancing as well as the preceding steps, and in particular the subsequent output of the information about the determined degree of balancing, are performed directly in response to a detected manual user input. For example, the predetermined user input may comprise pressing a button for a predetermined period of time, for example for at least three seconds.

Further preferably, the method further comprises the step of: outputting a wait signal immediately in response to detecting the user input and until determining the degree of balancing. That is, as the steps of sensing the single-cell voltages, determining the maximum voltage difference, and determining the degree of balancing are performed, a predetermined wait signal is output that signals the user that the method is being performed. For example, the wait signal comprises a predetermined visual signal, in particular a flashing pattern and/or a running light of several LEDs.

Particularly preferably, the sensing of the single-cell voltages is performed by way of a battery management system of the battery pack. In particular, the battery management system is configured for single-cell monitoring of the battery cells. In particular, the battery management system may be further configured to control functions of the battery pack. In particular, the further steps of determining the maximum voltage difference and determining the degree of balancing are also performed by the battery management system.

Preferably, the predetermined first threshold value, and additionally preferably the predetermined second threshold value, are specifically defined as a function of the electrical properties of the battery pack and/or the battery cells. In other words, the first threshold value, and in particular additionally the second threshold value, are defined based on empirically determined properties of the battery pack and/or a substantially electrically similar battery pack. That is to say, for example, the threshold values may be defined as a function of the electrical capacities of the battery cells.

Preferably, the predetermined first threshold value is at most 500 mV, in particular at most 300 mV, in particular at most 200 mV. Preferably, the predetermined second threshold value is at least 300 mV, in particular at least 500 mV. With the method, the calculation can thus be particularly simple and efficient.

Furthermore, the disclosure relates to a battery pack for loads comprising a plurality of battery cells, and a control unit configured to perform the described method. In particular, the battery pack is configured for an electrical and mechanical connection with loads in order to be able to supply the loads with electrical power.

Preferably, the battery pack further comprises a battery management system, which is configured to detect, in particular simultaneously, individual cell voltages of all battery cells of the battery pack. The control unit is part of the battery management system. That is to say, the described method may be performed by the technology already provided on the battery pack.

Preferably, the battery pack further comprises an output unit, in particular comprising an LED display. Further preferably, the battery pack comprises an input device comprising a button, preferably for manual user input.

### BRIEF DESCRIPTION OF THE DRAWINGS

An exemplary embodiment of the disclosure is described in detail below with reference to the accompanying drawings. The drawings show:

FIG. 1 a perspective view of a battery pack, in which a method according to a preferred exemplary embodiment of the disclosure is carried out, and

FIG. 2 a highly simplified schematic view of the method according to the disclosure.

### DETAILED DESCRIPTION

Preferably, all identical components, elements, and/or units are provided with the same reference signs in all figures.

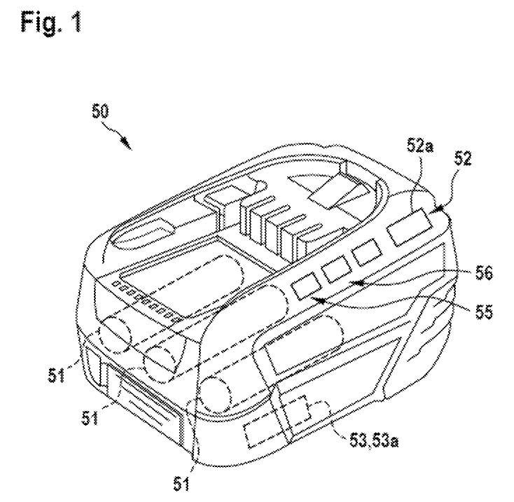

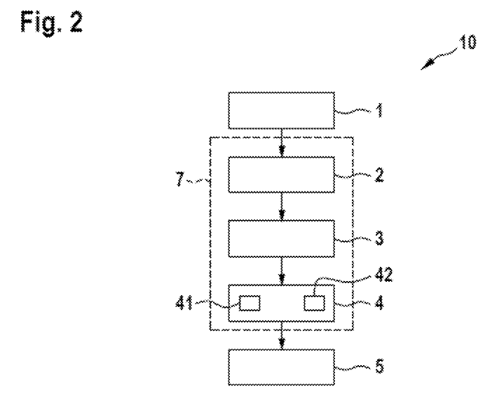

FIG. 1 shows a perspective view of a battery pack 50, in which a method 10 for operating the battery pack 50 according to a preferred exemplary embodiment of the disclosure is carried out. In FIG. 2, a highly simplified schematic view of the method 10 is shown.

The battery pack 50 is in particular designed as an exchangeable battery pack and provided as an electrical energy store for loads (not shown). For this purpose, the battery pack 50 comprises an electrical and mechanical interface for reversible connection with the loads.

The battery pack 50 comprises a plurality of battery cells 51, which are preferably identical in design.

The battery cells 3 are electrically connected in parallel and/or in series with one another.

Furthermore, the battery pack 50 comprises a battery management system 53 configured to control the battery pack 50, that is, in particular, to control the electrical energy supplied by the battery pack 50. Furthermore, the battery management system 53 is configured for single-cell monitoring of all battery cells 51.

Furthermore, the battery pack 50 comprises an output unit 56, which has an LED display 55 with a plurality of LEDs. For example, an instantaneous charge state of the battery pack 50 may be visually displayed by way of the LED display 55.

Also, the battery pack 50 includes an input device 52 with a button 51 that a user can manually operate. For example, in response to actuation of the button 52a, the instantaneous charge state can be visually displayed by lighting up the LED display 55.

The battery management system 53 comprises a control unit 53a configured to perform the method 10 for operating the battery pack 50.

The method 10 is performed in response to actuation of the button 52a. That is, the further method steps are performed in response to detecting 1 a predetermined user input using the input device 52. For example, actuating the button 52a for a predetermined period of time, such as at least three seconds, is considered to be a predetermined user input.

Subsequently, a preferably simultaneous or, alternatively preferably briefly successive, detection 2 of all individual voltages of all battery cells 51 of the battery pack 50 occurs.

Based on the detected individual voltages, a determination 3 of a maximum voltage difference between all individual voltages detected, in particular simultaneously or briefly in succession, is subsequently performed. In detail, a difference between the highest of all individual cell voltages and the lowest of all individual cell voltages is determined.

Subsequently, a degree of balancing is determined 4 by comparing the determined voltage difference with a predetermined first threshold value.

In the preferred exemplary embodiment shown, the determination 4 of the degree of balancing is carried out in two stages by using, in addition to the predetermined first threshold value, a predetermined second threshold value that is greater than the first threshold value.

By comparing the determined voltage difference with the first threshold value and the second threshold value, it is determined whether the battery cells 51 of the battery pack 50 are electrically balanced, partially imbalanced, or imbalanced.

In detail, a balanced state of the battery cells 51 is detected 41 if the determined voltage difference is less than or equal to the predetermined first threshold value.

If the determined voltage difference is greater than the predetermined first threshold value and, in particular, less than or equal to the predetermined second threshold value, detection 42 of the partially imbalanced state of the battery cells 51 occurs.

If the determined voltage difference is greater than the predetermined second threshold value, detection 42 of the imbalanced state of the battery cells 51 occurs.

With the method 10, information about the determined degree of balancing is output visually by way of the LED display 55 in response to the determination 4 of the degree of balancing.

Preferably, all LEDs of the LED display 55 illuminate when the balanced state has been detected. For example, upon detection 42 of the partially imbalanced state, some of the LEDs of the LED display 55, such as two out of a total of 3 LEDs, may illuminate.

Furthermore, upon detection 43 of the imbalanced state, none or exactly one of the LEDs of the LED display 55 may illuminate, for example.

The first and the second threshold values are predefined constant values, which are stored specifically as a function of the electrical properties of the battery pack 50. For example, the first threshold value is 200 mV and the second threshold value is 500 mV.

In method 10, outputting 7 a wait signal may further occur immediately in response to detecting 1 the user input and until determining 4 the degree of balancing, that is, until immediately prior to outputting 5 the information about the determined degree of balancing. For example, outputting the wait signal may comprise a running light through the LEDs of the LED display 55 or a predefined flashing pattern of the LED display 55.

By way of the method 10, the degree of balancing of the battery pack 50 can thus be visually indicated to the user. This may provide the user with information as to whether the current battery capacity of the battery pack 50 is OK when the balanced condition is determined, or is already reduced when the partially imbalanced condition is determined, or has already dropped to such an extent that a failure of the battery pack 50 will occur soon when the imbalanced condition has been determined.

The method 10 offers the advantage that it can be carried out particularly simply and cost-effectively and in a time-efficient manner. No additional elements are required, such as sensors or the like. In addition, no complex calculation methods or the like are required, since sensing the individual cell voltages is possible by way of the technology already present in the battery pack 50, and comparing the voltages is possible in particularly simple ways.

What is claimed is:

1. A method for operating a battery pack which has a plurality of battery cells, comprising:
sensing individual cell voltages of all battery cells;
determining a maximum voltage difference between all sensed individual cell voltages;
determining a degree of balancing by comparing the determined voltage difference with a predetermined first threshold value; and
outputting information about the determined degree of balancing by way of a charge state indicator of the battery pack, wherein at least a first degree of balancing and a second degree of balancing are indicated.

2. The method according to claim 1, wherein determining the degree of balancing comprises:
detecting a balanced state of the battery cells if the determined voltage difference is less than or equal to the predetermined first threshold value, and
detecting an at least partially imbalanced state of the battery cells if the determined voltage difference is greater than the predetermined first threshold value.

3. The method according to claim 2, wherein determining the degree of balancing further comprises:
detecting an imbalanced state of the battery cells if the determined voltage difference is greater than a predetermined second threshold value, wherein the second threshold value is greater than the first threshold value.

4. The method according to claim 1, wherein the first degree of balancing is present at a determined voltage difference below the first threshold value and the second degree of balancing is present at a determined voltage difference above the first threshold value, wherein the first degree of balancing corresponds to a failure-free battery pack and the second degree of balancing corresponds to a defective battery pack.

5. The method according to claim 4, wherein the output of the information occurs visually by way of an LED display.

6. The method according to claim 1, further comprising:
detecting a predetermined user input using an input device of the battery pack, wherein the further steps of the method are performed in response to detecting the predetermined user input.

7. The method according to claim 6, further comprising:
outputting a wait signal immediately in response to detecting the user input and until determining the degree of balancing.

8. The method according to claim 1, wherein sensing the individual cell voltages is performed by a battery management system of the battery pack.

9. The method according to claim 1, wherein the predetermined first threshold value and the predetermined second threshold value are specifically defined as a function of the electrical properties of the battery pack and/or the battery cells.

10. The method according to claim 1, wherein the predetermined first threshold value is at most 500 mV, and wherein the predetermined second threshold value is at least 300 mV.

11. A battery pack for loads, comprising:
a plurality of battery cells; and
a control unit configured to carry out the method according to claim 1.

12. The battery pack of claim 11, further comprising:
a battery management system configured to detect single cell voltages of all battery cells, wherein the control unit is part of the battery management system.

13. The battery pack according to claim 11, further comprising:
an output unit comprising an LED display, and/or
an input device comprising a button.

14. The method according to claim 1, wherein the battery pack is an interchangeable battery pack.

15. The method according to claim 2, wherein determining the degree of balancing further comprises:
detecting an impending failure of at least one battery cell if the determined voltage difference is greater than a predetermined second threshold value, wherein the second threshold value is greater than the first threshold value.

16. The method according to claim 4, wherein the output of the information occurs visually.

17. The method according to claim 1, wherein the predetermined first threshold value is specifically defined as a function of the electrical properties of the battery pack and/or the battery cells.

18. The method according to claim 1, wherein the predetermined first threshold value is at most 200 mV, and wherein the predetermined second threshold value is at least at least 500 mV.

19. The battery pack of claim 11, wherein the battery pack is an exchangeable battery pack.
